(19) United States
(12) Patent Application Publication
(10) Pub. No.: US 2014/0337355 A1
(43) Pub. Date: Nov. 13, 2014

(54) Indexed Natural Language Processing

(71) Applicant: Daniel Heinze, San Diego, CA (US)

(72) Inventor: Daniel Heinze, San Diego, CA (US)

(73) Assignee: GNOETICS, INC., San Diego, CA (US)

(21) Appl. No.: 14/230,652

(22) Filed: Mar. 31, 2014

Related U.S. Application Data
(60) Provisional application No. 61/822,597, filed on May 13, 2013.

(51) Int. Cl. G06F 17/30

(52) U.S. Cl. CPC G06F 17/30622; G06F 17/30666
USPC 707/742

(57) ABSTRACT

A method and computer program product for implementing indexed natural language processing are disclosed. Source document features including but not limited to terms, punctuation, parts-of-speech, phrases (including the syntactic types of the phrases), dependent clauses (including the syntactic types of the dependent clauses), independent clauses (including the syntactic types of the independent clauses), sentences, paragraphs, labeled document sections and document type and cognitive grammar constraints on the scope of influence and binding for the same are entered into an index by their begin and end byte offsets (or some alternative indexing method). Queries against the source documents are implemented as nested constructs that specify queries as sets that have terms or other sets as set elements and where sets may be constructed according to: 1) ordering (or the lack thereof); 2) boolean relations; 3) fuzzy relations; and 4) scoping according to: a) proximity; b) phrase inclusion; c) clause inclusion; d) sentence inclusion; e) paragraph inclusion; f) section inclusion; g) document type; and cognitive grammar constraints. Further, terms that are the components of a query are divided into sets according to the expected cognitive grammar relations between those terms as they would appear as surface forms in the source documents. As an aid to constructing queries in this manner, in some implementations, a surface form ontology is implemented in which the surface forms from which desired concepts can be expressed are represented according to their cognitive grammar compositions. Using these methods, queries can be composed that analyze the source documents via the intermediary of an index at a level of detail that has heretofore been possible only by application of standard Natural Language Processing (NLP) techniques directly to the source document. This novel application combining the strengths of cognitive grammar, surface form ontology and indexing results in information retrieval (IR) with significantly improved levels of recall and precision and information extraction (IE) with significantly improved flexibility and processing speeds over very large sets of data.

### CLAIM OF PRIORITY

This application claims priority under 35 USC §119(e) to U.S. Patent Application Ser. No. 61/822,597, filed on May 13, 2013, the entire contents of which are hereby incorporated by reference.

### CROSS-REFERENCE TO RELATED APPLICATIONS

Utility Patent Application: A Method and Computer Program Product for Detecting and Identifying Erroneous Medical Abstracting and Coding and Clinical Documentation Omissions; Inventor: Daniel T. Heinze, San Diego, Calif.; Assignee: Gnoetics, Inc., San Diego, Calif. (hereafter referred to as “RELATED APPLICATION”)

### STATEMENT REGARDING FEDERALLY SPONSORED RESEARCH OR DEVELOPMENT

Not Applicable

### REFERENCE TO SEQUENCE LISTING, A TABLE, OR A COMPUTER LISTING COMPACT DISK APPENDIX

Not Applicable

### TECHNICAL FIELD

The following disclosure relates to methods and computerized tools for performing Natural Language Processing (NLP) tasks on source documents indirectly using novel indexed content, a novel set of query operators and a novel method of composing the linguistic surface forms of query concepts using a natural language surface form ontology.

### BACKGROUND OF THE INVENTION

Free-text Information Retrieval (IR), the location and retrieval of stored free-text document, is typically performed simultaneously on a large collection of stored or source documents via the intermediary of an index of terms that occur in the source documents to their location. The mapping of a query concept, composed of query terms, onto a set of zero or more source documents can be very fast if the index terms are searchable by means of a rapid search methods such as hashing and inverted-indexing. IR is designed to produce rapid search results for a single or limited set of query concepts against potentially very large document sets.

Natural Language Processing (NLP), the detailed analysis of free-text documents typically consisting of lexical, syntactic, semantic and pragmatic analysis, is typically performed by direct operation on one source document at a time but will produce results related to many concepts during a single analysis pass on that document.

By comparison to indexed IR, NLP is very slow, but NLP can provide a much higher degree of analytical accuracy and a greater depth of analytical detail in terms of identifying or extracting specific information contained in source documents. In addition to being slow, NLP is less flexible in that if even one of potentially thousands of concepts in the system needs to be changed or updated, the time to reanalyze a document set is the same as if all the concepts had changed.

It is desirable, therefore, to have a method, here referred to as indexed NLP employing techniques of grammatical indexing, that achieves the analytical power of NLP with the computational efficiency and speed of indexed IR. This is particularly true when the number of documents to be analyzed far exceeds the number of concepts to be mapped. For example, in the field of medicine, it is frequently desirable to run an NLP engine that includes tens of thousands of medical finding, diagnosis and procedure concepts against tens of thousands of documents. However, with the rise of “Big Data” consolidating or connecting to multiple sources the need to perform rapid, in depth analysis of millions or even billions of documents arises. Also needed is the flexibility to rapidly update analysis results for frequent changes to small numbers of the tens of thousands of query and extraction concepts. A method and computer

In applications where the number of concepts for regular (vs. ad hoc) query and extraction is very large (e.g. medicine), and where the linguistic surface forms expressing a concept are complex and varied, the need arises for a method, here referred to as surface form ontology, to represent the concepts in a structure that represents the cognitive grammar composition of linguistic surface forms representing each concept, can be mapped to indexed NLP query form, and is straight-forward to develop and maintain.

A method and computer program product of indexed NLP that uses novel grammatical indexing and surface form ontology combined with traditional IR indexing and search methods thus producing rapid, flexible and deep analysis, mapping concepts to source documents for retrieval and information extraction is disclosed.

### SUMMARY OF THE INVENTION

Techniques for performing NLP via the intermediary of an index on a source document set (from here on, the “source document set” or a “source document” will be referred to respectively as “documents” or “document”) of arbitrary size are disclosed. While the following describes techniques in context of medical coding and abstracting and are particularly exemplified with respect to coding medical documents, some or all of the disclosed techniques can be implemented to apply to any text or language processing system in which it is desirable to perform NLP analysis tasks against some documents.

In one aspect, documents in electronic form are indexed on the document terms, parts-of-speech, phrases, clauses, sentences, paragraphs, sections and document source/type. Terms may be single word or a multi-word and are indexed to the begin/end byte offsets within each document in which they occur and to their part-of-speech per occurrence. Phrases, according to their type (e.g. prepositional phrase, noun phrase, verb phrase, etc.), clauses, according to their type (e.g. dependent, independent, etc.), sentences (and sentence fragments), according to their type (e.g. declaration, question, etc.), paragraphs, and sections, according to their type (e.g. subjective, objective, assessment, plan, etc.) are indexed to the begin/end byte offsets within each document in which they occur. Further, principles of cognitive grammar are applied to delimit and index the scope over which a term, phrase, clause, sentence, or paragraph may have influence. Indexed scopes may be nested or overlapping. Document source/type (e.g. lab reports, office visits, discharge summaries, etc.) are indexed to the documents of that source/type.

A query is a construct of concepts that can be mapped onto documents via the index. The constructors for a query are set operators that can be satisfied against the index. Traditional query operators include but are not limited to Boolean, Fuzzy Set, term order and term proximity operators. To these we here add the novel query operators of phraseConstraint, clauseConstraint, sentenceConstraint, paragraphConstraint, sectionConstraint, source/typeConstraint, and scope constraint each relating to the indexing of location (begin/end byte offset and document) and, as applicable, being indexed to the grammatical type (e.g. syntactic category, cognitive grammar category etc.) of the occurrences in the documents. In this way, query terms can be subjected to syntactic, semantic and pragmatic grammatical constraints (the operators and grammatical constraints will heretofore be referred to as “grammatical operators”). For example, the query “source/typeConstraint( radiology, #sectionConstraint(assessment, phraseConstraint(null, and(rib fracture))))” would require that both the terms “rib” and “fracture” occur within the same phrase (phrase grammatical type not specified), within the assessment section of a radiology document.

The concepts that are constructed to form a query may themselves be complex. The construction of an effective query from a complex concept can be difficult. If the surface forms of the concepts are represented in a surface form ontology as described in RELATED APPLICATION, they can be directly mapped to an indexed NLP query form according to method here disclosed.

Implementation can optionally include one or more of the following features. In the RELATED APPLICATION ontology, the surface forms that describe the concepts are composed of a finite set of semantic categories. For example, “rib fracture due to blunt trauma” would be composed of diagnosis( diagnosis(anatomicLocation(rib) and morphologicalAbnormality(fracture)) and environmentalCause(environmentalCause(trauma) modifier(blunt))). Using the unconstrained surface form “rib fracture due to blunt trauma” would likely produce low accuracy results in terms of recall (retrieving all the documents containing the concept) and precision (retrieving only the documents containing the concept). The RELATED APPLICATION surface form ontology representation can be, however, automatically translated into an indexed NLP query consisting of grammatical operators and/or traditional operators by assigning to each surface form ontology component a mapping to one or more grammatical operators and/or traditional operators. Mapping types include but are not limited to: 1) surface form A must occur within a single phrase of optional type X; 2) surface form A.1 to A.n must each appear within a single phrase of optional type X and must all occur with a single clause of optional type Y; 3) surface form A must follow/proceed/co-occur with surface form B within a clause; 4) surface form A must follow/proceed/co-occur with surface form B within a clause without the occurrence of surface form C between; 5) surface form A and surface form B must occur within N contiguous sentences within the same paragraph; 6) surface form A and surface form B must occur within the same paragraph; 7) surface form A and surface form B must occur within the same section; 8) surface form A and surface form B must occur within the same document; 9) surface form A and surface form B must occur within documents that are both indexed to surface form C; where surface form may be a surface form component, a set of surface form components, a surface form, or a set of surface forms as specified by the ontology, or a construct of surface form components, surface forms or surface form sets constructed with the grammatical operators and/or traditional operators.

By associating surface form components and surface forms in the ontology with particular grammatical operators and traditional operators, surface form ontology representations may be automatically translated to indexed NLP queries for information retrieval and extraction.

These aspects can be implemented using an apparatus, a method, a system, or any combination of an apparatus, methods, and systems. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1A is a functional block diagram of an indexed NLP system.

FIG. 1B is a functional block diagram of an indexed NLP system executing on a computer system.

FIG. 1C is a functional block diagram of a grammar operator indexing application.

FIG. 2 is a flow chart of a grammatical analysis system.

FIG. 3 is a flow chart showing a detailed view of a query generator application.

Like reference symbols in the various drawings indicate like elements.

### DETAILED DESCRIPTION OF THE INVENTION

Techniques for performing NLP via the intermediary of an index on a source document set of arbitrary size are disclosed. While the following describes techniques in context of medical coding and abstracting and are particularly exemplified with respect to coding medical documents, some or all of the disclosed techniques can be implemented to apply to any text or language processing system in which it is desirable to perform NLP analysis tasks against some documents.

Various implementations of indexed NLP are possible. The implementation of techniques for grammatical operators used in the method for indexed NLP are based in and include, but are not limited to, the use of under-specified syntax as embodied in NLP software systems developed by Gnoetics, Inc. and in commercial use since 2009 and the L-space semantics as published in Daniel T. Heinze, “Computational Cognitive Linguistics”, doctoral dissertation, Department of Industrial and Management Systems Engineering, The Pennsylvania State University, 1994 (Heinze-1994). Extending the techniques embodied or described in these sources, novel techniques for indexed NLP are disclosed.

In one aspect, documents in electronic form are indexed by an inverted-index of the document terms, parts-of-speech, phrases, clauses, sentences, paragraphs, sections and document source/type. In addition to inverted-index, any competent method for indexing or mapping may be employed without departing from the spirit and scope of the claims. Terms may be single word or a multi-word and are indexed to the begin/end byte offsets within each document in which they occur and to their part-of-speech per occurrence. Phrases, according to their type (e.g. prepositional phrase, noun phrase, verb phrase, etc.), clauses, according to their type (e.g. dependent, independent, etc.), sentences (and sentence fragments), according to their type (e.g. declaration, question, etc.), paragraphs, and sections, according to their type (e.g. subjective, objective, assessment, plan, etc.) are indexed to the begin/end byte offsets within each document in which they occur. Document source/type (e.g. lab reports, office visits, discharge summaries, etc.) are indexed to the documents of that source/type. Applying principles of cognitive grammar (Heinze-1994), the scope over which a term, phrase, clause, sentence, paragraph, section or document exercises influence or within which it may bind is indexed. Indexed scopes may be nested or overlapping.

A query is a construct of concepts that can be mapped onto documents via the index. The constructors for a query are set operators that can be satisfied against the index. Traditional query operators include but are not limited to Boolean, Fuzzy Set, term order and term proximity operators. To these here are added the novel query operators of phraseConstraint, clauseConstraint, sentenceConstraint, paragraphConstraint, sectionConstraint, source/typeConstraint, and scopeConstraint each relating to the indexing of location (begin/end byte offset and document) and, as applicable, being indexed to the grammatical type (e.g. syntactic category, etc.) of the occurrences in the documents. In this way, query terms can be subjected to syntactic, semantic and pragmatic grammatical constraints (the operators and grammatical constraints will heretofore be referred to as “grammatical operators”). For example, the query “source/typeConstraint(radiology, #sectionConstraint(assessment, phraseConstraint(null, and(rib fracture))))” would require that both the terms “rib” and “fracture” occur within the same phrase (phrase grammatical type not specified), within the assessment section of a radiology document.

The concepts that are constructed to form a query may themselves be complex. The construction of an effective indexed NLP query from a complex concept can be difficult. If the surface forms of the concepts are represented in a surface form ontology based on the cognitive grammar in Heinze-1994, they can be directly mapped to indexed NLP query form according to the here disclosed method.

Implementation can optionally include one or more of the following features. In the Heinze-1994 and RELATED APPLICATION ontology, the surface forms that describe the concepts are composed of a finite set of semantic categories. For example, “rib fracture due to blunt trauma” would be decomposed to diagnosis(diagnosis(anatomicLocation(rib) and morphologicalAbnormality(fracture)) and environmentalCause( environmentalCause(trauma) modifier(blunt))). Using the unconstrained surface form “rib fracture due to blunt trauma” would likely produce low accuracy results in terms of recall (retrieving all the documents containing the concept) and precision (retrieving only the documents containing the concept). The RELATED APPLICATION surface form ontology representation can be, however, automatically translated into an indexed NLP query consisting of grammatical operators and/or traditional operators by assigning to each surface form ontology component a mapping to one or more grammatical operators and/or traditional operators. Mapping types include but are not limited to: 1) surface form A must occur within a single phrase of optional type X; 2) surface form A.1 to A.n must each appear within a single phrase of optional type X and must all occur with a single clause of optional type Y; 3) surface form A must follow/proceed/co-occur with surface form B within a clause; 4) surface form A must follow/proceed/co-occur with surface form B within a clause without the occurrence of surface form C between; 5) surface form A and surface form B must occur within N contiguous sentences within the same paragraph; 6) surface form A and surface form B must occur within the same paragraph; 7) surface form A and surface form B must occur within the same section; 8) surface form A and surface form B must occur within the same document; 9) surface form A and surface form B must occur within documents that are both indexed to surface form C; where surface form may be a surface form component, a set of surface form components, a surface form, or a set of surface forms as specified by the ontology, or a construct of surface form components, surface forms or surface form sets constructed with the grammatical operators and/or traditional operators.

By associating surface form components and surface forms in the ontology with particular grammatical operators and traditional operators, surface form ontology representations are automatically translated to indexed NLP queries for information retrieval and extraction.

Indexed Natural Language Processing System Design

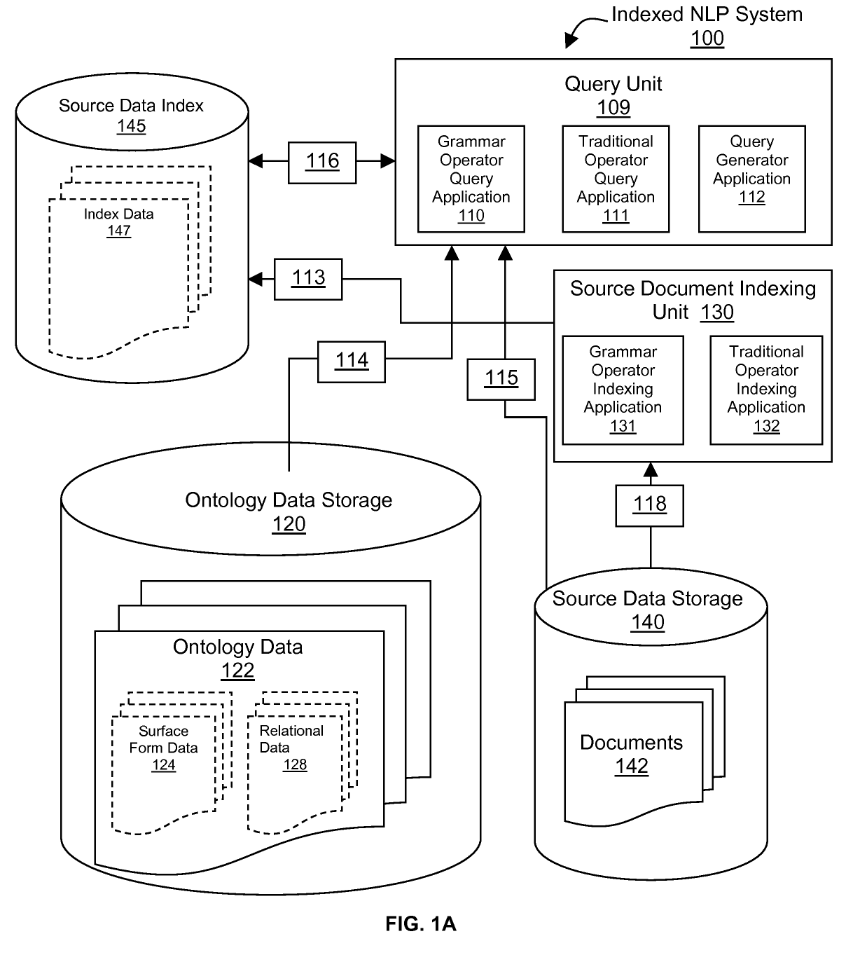

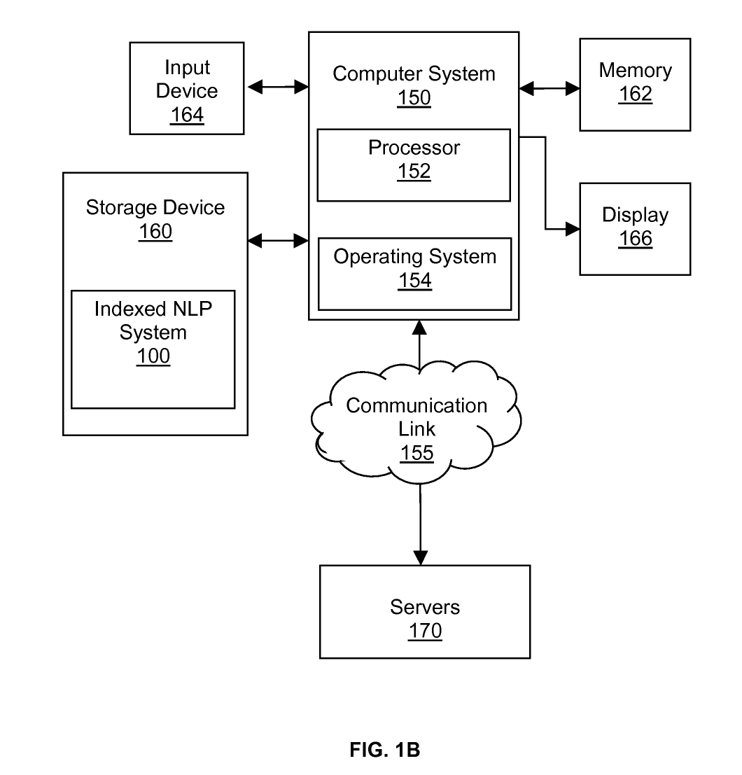

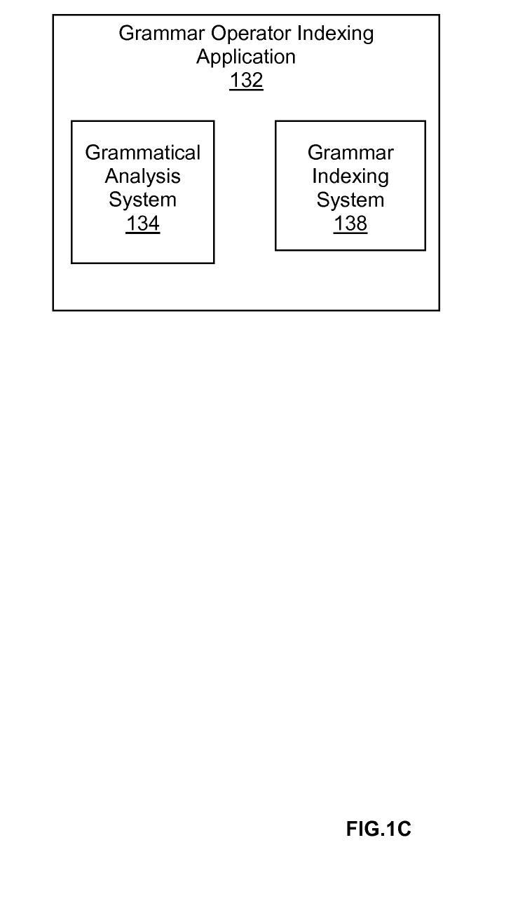

FIG. 1A is a functional diagram of indexed NLP system 100. Indexed NLP system 100 includes source document indexing Unit 130 and query unit 109. Source document indexing unit 130 includes grammar operator indexing application 131 and traditional operator indexing application 132. Query unit 109 includes grammar operator query application 110, traditional operator query application 111, and query generator application 112. Grammar operator indexing application 131 and traditional operator indexing application 132 are communicatively coupled to source data storage 140 through communications link 118 and are communicatively coupled to source data index 145 through communications link 113. Grammar operator query application 110, traditional operator query application 111, and query generator application 112 are communicatively coupled to source data storage 140 through communications link 115, are communicatively coupled to ontology data storage 120 through communications link 114, and are communicatively coupled to source data Index 145 through communications link 116. Source data Index 145 may contain index data 147. Source data storage 145 may contain documents 142. Ontology data storage 120 may contain ontology data 122. Ontology data 122 may contain surface form data 124 and relational data 128.

FIG. 1B is a block diagram of indexed NLP system 100 implemented as software or a set of machine executable instructions executing on a computer system 150 such as a local server in communication with other internal and/or external computers or servers 170 through communication link 155, such as a local network or the internet. Communication link 155 can include a wired and/or a wireless network communication protocol. A wired network communication protocol can include local wide area network (WAN), broadband network connection such as Cable Modem, Digital Subscriber Line (DSL), and other suitable wired connections. A wireless network communication protocol can include WiFi, WIMAX, BlueTooth and other suitable wireless connections.

Computer system 150 includes a central processing unit (CPU) 152 executing a suitable operating system (OS) 154 (e.g., Windows® OS, Apple® OS, UNIX, LINUX, etc.), storage device 160 and memory device 162. The computer system can optionally include other peripheral devices, such as input device 164 and display device 166. Storage device 160 can include nonvolatile storage units such as a read only memory (ROM), a CD-ROM, a programmable ROM (PROM), erasable program ROM (EPROM) and a hard drive. Memory device 162 can include volatile memory units such as random access memory (RAM), dynamic random access memory (DRAM), synchronous DRAM (SDRAM) and double data rate-synchronous DRAM (DDRAM). Input device 164 can include a keyboard, a mouse, a touch pad and other suitable user interface devices. Display device 166 can include a Cathode-Ray Tube (CRT) monitor, a liquid-crystal display (LCD) monitor, or other suitable display devices. Other suitable computer components such as input/output devices can be included in or attached to computer system 150.

In some implementations, indexed NLP system 100 is implemented as a web application (not shown) maintained on a network server (not shown) such as a web server. Indexed NLP system 100 can be implemented as other suitable web/network-based applications using any suitable web/network-based computer programming languages. For example Java, C/C++, an Active Server Page (ASP), and a JAVA Applet can be implemented. When implemented as a web application, multiple end users are able to simultaneously access and interface with indexed NLP system 100 without having to maintain individual copies on each end user computer. In some implementations, indexed NLP system 100 is implemented as a local application executing in a local end user computer or as client-server modules, either of which may be implemented in any suitable programming language, environment or as a hardware device with the application's logic embedded in the logic circuit design or stored in memory such as PROM, EPROM, Flash, etc.

In some implementations, indexed NLP system 100 is implemented as a distributed system across multiple instances of computer system 150 each of which may contain zero or more source document index unit 130, query unit 109, source data storage 140 ontology data storage 120, and source data index 145, in which implementation communications links 113, 114 115, 116 and 118 will, as needed, be web application communications links between the required instances of computer system 150.

Traditional Operator Indexing Application

Traditional operator indexing application 132 may be any competent indexing application or set of applications that may include but are not limited to inverted-indexing, tree or graph search, hashing, etc. and may include, but is not limited to, features such as term indexing, multi-word indexing, stop wording, stemming, lemmatization, and case normalization.

Grammar Operator Indexing Application

FIG. 1C is a detailed view of grammar operator indexing application 132, which includes grammatical analysis system 134 and grammar indexing system 138. Grammatical analysis system 134 can be implemented using a combination of finite state automata (FSA) and syntax parsers including but not limited to context-free grammars (CFG), context sensitive grammars (CSG), phrase structure grammars (PSG), head-driven phrase structure grammars (HPSG), or dependency grammars (DG), which can be implemented in Java, C/C++ or any competent programming language and may be configured manually or from training examples using machine learning. Grammar indexing system 138 can be implemented in Java, C/C++ or any competent programming language.

Grammatical Analysis System Algorithm

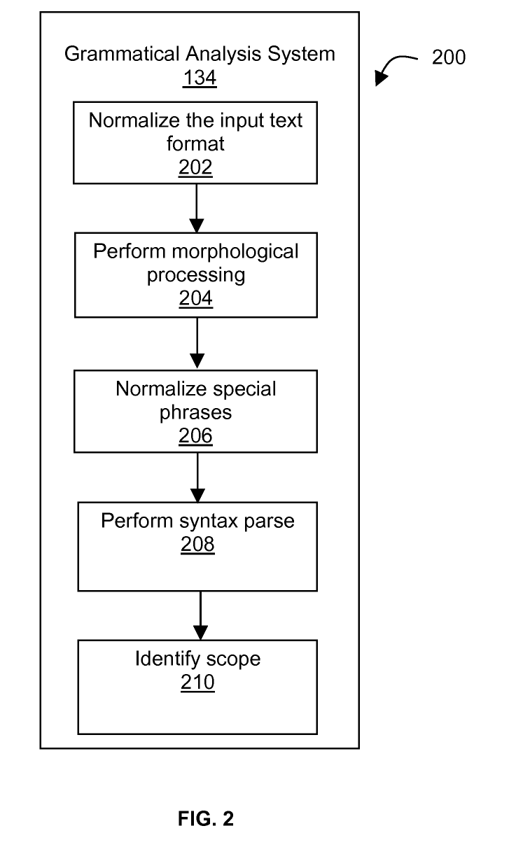

FIG. 2 is a flow chart of process 200 for implementing grammatical analysis system 134. Given each source input text document from documents 142, which includes words, numbers, punctuations and white or blank spaces to be parsed, grammatical analysis system 134 begins by normalizing the document to a standardized plain text format at 202. Normalizing to a standardized plain text format can include converting the document, which may be in a word processor format (e.g., Word®), XML, HTML or some other mark-up format, to a plain text using either ASCII or some application dependent form of

Unicode. The normalization process also includes annotating the byte offsets of the beginning and ending of document sections, headings, white space, terms and punctuation so that any mappings to ontology data 122, or specifically to surface form data 124, can be mapped back to the original location in documents 142.

The normalized input text is morphologically processed at 204 by morphing the words, numbers, acronyms, etc. in the input text to one or more predetermined standardized formats. Morphological processing can include stemming, normalizing units of measure to desired standards (e.g. SAE to metric or vice versa) and contextually based expansion of acronyms. The normalized and morphologically processed input text is processed to identify and normalize special words or phrases at 206. Special words or phrases that may need normalizing can include words or phrases of various types such as temporal and spatial descriptions, medication dosages, or other application dependent phrasing. In medical texts, for example, a temporal phrase such as “a week ago last Thursday” can be normalized to a specific number of days (e.g., seven days) and an indication that it is past time.

At 208, the grammatical analysis system 134 is implemented to perform syntax parse 208 of the normalized input text and identify the part-of-speech of each term and punctuation, the scope of phrases, the scope of clauses, and the syntactic features of each including but not limited to phrase heads and dependencies. The syntax parse data are stored as annotations for use in ensuing processes. In some implementations, the data structure for representing the annotations includes arrays, trees, graphs, stacks, heaps or other suitable data structure that maintains a view of the generated annotations that can be mapped back to the location of the annotated item in source documents 142. Annotation data 147 produced by grammatical analysis system 134 are stored in annotation data storage 145.

As a refinement to the annotations produced by perform syntax parse 201, identify scope 210 produces further annotation data 147 that identifies the syntactic scope within which terms and punctuation may be combined and for attempted mapping to the ontology data 122 as surface form data 124 and by grammar operator query application 110 and traditional operator query application 111.

Grammar Indexing System Algorithm

Annotations produced by grammatical analysis system 134 are converted to indexes by grammar indexing system 138 and are stored in source data index 145 as index data 147. Index data 147 may be any competent indexing or look-up methodology including but not limited to inverted-index, hashing, graph or tree structure. Grammar indexing system 138 uses the annotations from grammatical analysis system 134 to create index data 147 of one or more of the following grammar constraint type in source data index 145:

1. tokenConstraint,

2. phraseConstraint,

3. clauseConstraint,

4. sentenceConstraint,

5. paragraphConstraint,

6. sectionConstraint,

7. source/typeConstraint,

8. scopeConstraint

each (1-8) relating to the indexing of location (begin/end byte offset and document of documents 142) in index data 147 and, as applicable, being constrained by being indexed in index data 147 to the grammatical type (e.g. part-of-speech, syntactic category, etc.) of each occurrence in documents 142.

Traditional Operator Query Application Algorithms

Traditional operator query application 111 algorithms include but are not limited to Boolean, Fuzzy Set, term order and term proximity operators.

Traditional operator query application 111 algorithms are implemented in such a manner that the traditional operator query application 111 and grammar operator query application 110 can interact in a manner that permits the intermingling and interaction of traditional and grammar operators in query unit 109.

Grammar Operator Query Application Algorithm

Grammar operator query application 110 implements grammatical operators that include but are not limited to:

1. surface form A must occur within a single phrase;

2. surface form A.1 to A.n must each appear within a single phrase and must all occur with a single clause;

3. surface form A must follow/proceed/co-occur with surface form B within a clause;

4. surface form A must follow/proceed/co-occur with surface form B within a clause without the occurrence of surface form C between;

5. surface form A and surface form B must occur within N contiguous sentences within the same paragraph;

6. surface form A and surface form B must occur within the same paragraph;

7. surface form A and surface form B must occur within the same section;

8. surface form A and surface form B must occur within the same document;

9. surface form A and surface form B must occur within documents that are both indexed to surface form C;

1. Where surface form may be

1.a. a surface form component,

1.b. a surface form,

1.c. a set of surface forms as specified in ontology surface form data 124, or

1.d. a construct of surface form components, surface forms or set of surface forms constructed with some grammatical operators and/or traditional operators or some combination(s) of grammatical operators and/or traditional operators, and

2. Where surface form is mapped to specific locations in documents 142 by query unit 109 using index data 147, and

3. Where surface form may be constrained by specification of some grammar constraint type as indexed in index data 147 by grammar indexing system 138.

Query Generator Application Algorithm

Query generator application 112 receives surface form data 124 and relational data 128 from ontology data 122. In ontology data 122, surface form data 124 is composed of a finite set of surface form semantic categories that may optionally be organized in taxonomy. The surface form semantic categories that are chosen are application specific. For clinical medicine, the surface form semantic categories include but are not limited to:

1. Finding

1.a. Disease

1.b. Abnormality

1.c. Measurement

1.d. Substance

1.d.i. Medication

1.d.ii. Environmental substance or artifact

1.d.iii. Bodily substance

1.d.iv. Medical artifact

1.e. Procedure

2. Anatomic entity

3. Modifier

3.a. Spatial relation modifier

3.b. Other modifiers

3.b.i. Certainty

3.b.ii. Severity

3.b.iii. Reporting source

3.b.iv. Timing

3.b.v. Ordinal

3.b.vi. Cardinality

such that each term in each surface form in surface form data 124 is designated by the surface form semantic category in which said term functions in each surface form, and

each surface form semantic category is linked in relational data 128 to some grammar constraint type, and

each term in each surface form in surface form data 124 is related in relational data 128 to each other term in the same surface form with which it shares one or more relations as specified by grammar constraint type.

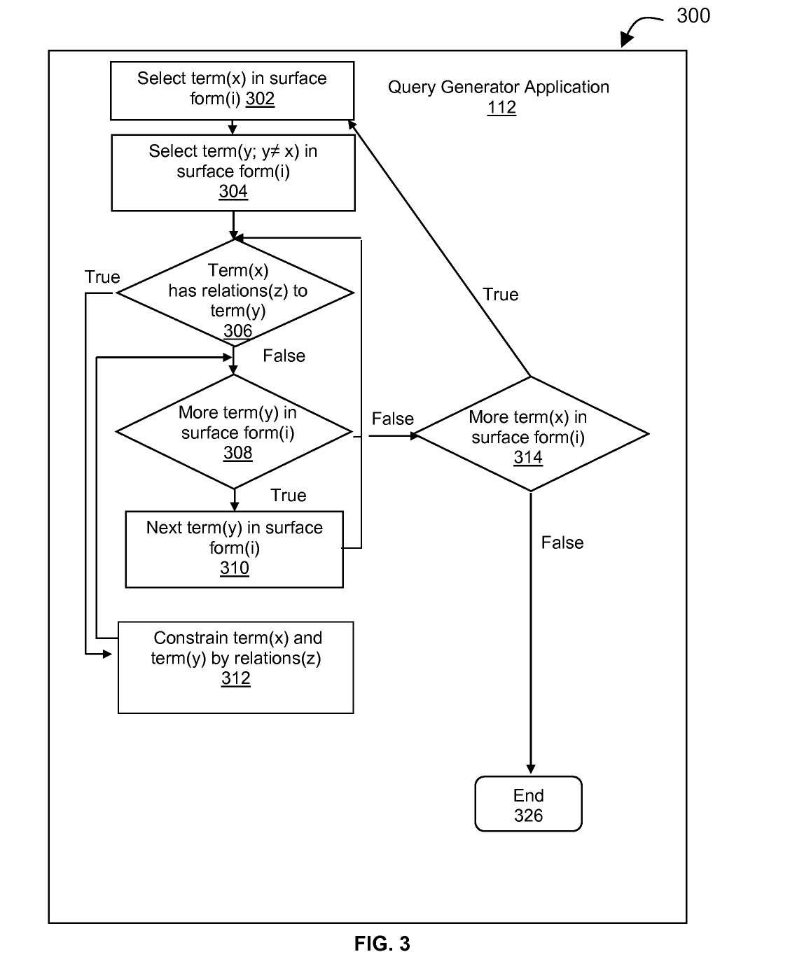

FIG. 3 is a flow chart of process 300 for implementing query generator application 112. 302: Select term(x) in surface form(i) where surface form(i) is in surface form data 124. 304: Select term(y) in surface form(i) where y≠x. 306: if term(x) and term(y) have one or more relations(z) as specified in relational data 128, then 312: constrain term(x) and term(y) by each of relations(z); else 308: if there are more term(y) in surface form(i), then 310: get the next term(y) in surface form(i) and iterate at 306; else 314: if more term(x) in surface form(i); then iterate at 302; else 326: End.

Computer Implementations

In some implementations, the techniques for implementing indexed

NLP as described in FIGS. 1A to 3 can be implemented using one or more computer programs comprising computer executable code stored on a computer readable medium and executing on indexed NLP system 100. The computer readable medium may include a hard disk drive, a flash memory device, a random access memory device such as DRAM and SDRAM, removable storage medium such as CD-ROM and DVD-ROM, a tape, a floppy disk, a CompactFlash memory card, a secure digital (SD) memory card, or some other storage device.

In some implementations, the computer executable code may include multiple portions or modules, with each portion designed to perform a specific function described in connection with FIGS. 1A to 3 above. In some implementations, the techniques may be implemented using hardware such as a microprocessor, a microcontroller, an embedded microcontroller with internal memory, or an erasable programmable read only memory (EPROM) encoding computer executable instructions for performing the techniques described in connection with FIGS. 1A to 3. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiments have been described. Nevertheless, it will be understood that various modifications may be made without departing from the spirit and scope of the claims. Accordingly, other embodiments are within the scope of the following claims.

What is claimed is:

1. A method comprising:
identifying term locational information for terms in documents that exist in the form of text data;
identifying term grammatical information for terms in documents that exist in the form of text data;
indexing term locational information for terms in documents that exist in the form of text data;
indexing term grammatical information for terms in documents that exist in the form of text data;
storing the indexed information;
constructing queries consisting of one or more locational and grammatical constraints on one or more terms;
performing information retrieval and information extraction by satisfying the queries against the stored indexed information;

2. A method of implementing claim 1 comprising:
identifying term locational information for terms in documents that exist in the form of text data;
identifying term grammatical information for terms in documents that exist in the form of text data;
indexing term locational information for terms in documents that exist in the form of text data;
indexing term grammatical information for terms in documents that exist in the form of text data;
storing the indexed information;
constructing queries consisting of one or more locational and grammatical constraints on one or more terms;
performing information retrieval and information extraction by satisfying the queries against the stored indexed information;

3. A method of implementing claim 2 wherein identifying term locational information for terms in documents that exist in the form of text data comprises:
identifying locational information as location within a particular document;
identifying locational information as begin/end byte offset within a particular document;

4. A method of implementing claim 2 wherein identifying term grammatical information for terms in documents that exist in the form of text data comprises:
identifying grammatical information as part-of-speech for a term;
identifying grammatical information as syntactic category to a term;
identifying grammatical information as syntactic category of a group of terms;
identifying grammatical information as structural relations between terms or groups of terms;
identifying grammatical information as semantic relations between terms of groups of terms;
identifying grammatical information as pragmatic relations between terms or groups of terms;
identifying grammatical information as cognitive grammar scoping relations between terms or groups of terms;

5. The method of claim 2, wherein indexing term locational information comprises:
Identifying the document in which each term appears;
calculating the term begin/end byte offsets of each appearance of each term in each document;
storing the document identification and each begin/end byte offset for each appearance of each term in each document in an index;

6. The method of claim 2, wherein indexing term grammatical information comprises:
identifying the grammatical information associated with each occurrence of each term;
calculating the term begin/end byte offsets of each appearance of each term;
storing the document identification, grammatical information and each begin/end byte offset for each appearance of each term in an index;

7. The method of claim 2, wherein indexing term grammatical information further comprises:
identifying the document in which each term appears;
identifying grammatical relations between groups of terms within a document;
calculating the term begin/end byte offsets of each appearance of each grammatically related term group in each document;
storing each document identification, grammatical information and each begin/end byte offset for each appearance of each grammatically related term group in an index;

8. The method of claim 2, wherein indexing term grammatical information further comprises:
identifying the document in which each grammatically related term group appears;
identifying grammatical relations between grammatically related term groups;
calculating the term begin/end byte offsets of each appearance of each grammatically related group of grammatically related term groups;
storing the document identification, grammatical information and each begin/end byte offset for each appearance of each group of grammatically related term groups in an index;

9. The method of claim 2, wherein indexing term grammatical information further comprises:
identifying the document in which each term, grammatically related term group or group of grammatically related term groups appears;
identifying grammatical relations between groups of terms within a document;
calculating the term begin/end byte offsets of each appearance of each grammatically related term group in each document;
storing the document identification, grammatical information and each begin/end byte offset for each appearance of each grammatically related term group in each document in an index;

10. The method of claim 2, wherein constructing queries consisting of one or more locational and grammatical constraints on one or more terms comprises:
creating ontology surface form data for the intended query concepts;
identifying the semantic category of each term in each ontology surface form;
identifying the grammatical relations between the terms in each surface form, which grammatical relations must be satisfied by a surface form in some document for the query to be satisfied;
automatically translating the ontology surface form to a query using the correct syntax and semantics for the locational and grammatical constraints of the query application;

11. A computer program product, encoded on a computer-readable medium, operable to cause data processing apparatus to perform operations comprising:
identifying term locational information for terms in documents that exist in the form of text data;
identifying term grammatical information for terms in documents that exist in the form of text data;
indexing term locational information for terms in documents that exist in the form of text data;
indexing term grammatical information for terms in documents that exist in the form of text data;
storing the indexed information;
constructing queries consisting of one or more locational and grammatical constraints on one or more terms;
performing information retrieval and information extraction by satisfying the queries against the stored indexed information;

12. The computer program of claim 11, wherein identifying term locational information for terms in documents that exist in the form of text data comprises:
identifying locational information as location within a particular document;
identifying locational information as begin/end byte offset within a particular document;

13. The computer program of claim 11, wherein identifying term grammatical information for terms in documents that exist in the form of text data comprises:
identifying grammatical information as part-of-speech for a term;
identifying grammatical information as syntactic category to a term;
identifying grammatical information as syntactic category of a group of terms;
identifying grammatical information as structural relations between terms or groups of terms;
identifying grammatical information as semantic relations between terms of groups of terms;
identifying grammatical information as pragmatic relations between terms or groups of terms;
identifying grammatical information as cognitive grammar scoping relations between terms or groups of terms;

14. The computer program of claim 11, wherein indexing term locational information comprises:
Identifying the document in which each term appears;
calculating the term begin/end byte offsets of each appearance of each term in each document;
storing the document identification and each begin/end byte offset for each appearance of each term in each document in an index;

15. The computer program of claim 11, wherein indexing term grammatical information comprises:
identifying the grammatical information associated with each occurrence of each term;
calculating the term begin/end byte offsets of each appearance of each term;
storing the document identification, grammatical information and each begin/end byte offset for each appearance of each term in an index;

16. The computer program of claim 11, wherein indexing term grammatical information further comprises:
identifying the document in which each term appears;
identifying grammatical relations between groups of terms within a document;
calculating the term begin/end byte offsets of each appearance of each grammatically related term group in each document;
storing each document identification, grammatical information and each begin/end byte offset for each appearance of each grammatically related term group in an index;

17. The computer program of claim 11, wherein indexing term grammatical information further comprises:
identifying the document in which each grammatically related term group appears;
identifying grammatical relations between grammatically related term groups;
calculating the term begin/end byte offsets of each appearance of each grammatically related group of grammatically related term groups;
storing the document identification, grammatical information and each begin/end byte offset for each appearance of each group of grammatically related term groups in an index;

18. The computer program of claim 11, wherein indexing term grammatical information further comprises:
identifying the document in which each term, grammatically related term group or group of grammatically related term groups appears;
identifying grammatical relations between groups of terms within a document;
calculating the term begin/end byte offsets of each appearance of each grammatically related term group in each document;
storing the document identification, grammatical information and each begin/end byte offset for each appearance of each grammatically related term group in each document in an index;

19. The computer program of claim 11, wherein constructing queries consisting of one or more locational and grammatical constraints on one or more terms comprises:
creating ontology surface form data for the intended query concepts;
identifying the semantic category of each term in each ontology surface form;
identifying the grammatical relations between the terms in each surface form, which grammatical relations must be satisfied by a surface form in some document for the query to be satisfied;
automatically translating the ontology surface form to a query using the correct syntax and semantics for the locational and grammatical constraints of the query application;
